(19) United States
(12) Patent Application Publication
(10) Pub. No.: US 2009/0006272 A1
(43) Pub. Date: Jan. 1, 2009

(54) METHODS FOR REORGANIZING AN EQUITY FLOAT STRUCTURE

(75) Inventor: David Korman, Los Altos, CA (US)

Correspondence Address: David Korman, 4546 B-10 El Camino Real #288, Los Altos, CA, 94022, US

(73) Assignee: David Korman, Los Altos, CA (US)

(21) Appl. No.: 12/140,538

(22) Filed: Jun. 17, 2008

Related U.S. Application Data
(60) Provisional application No. 60/936,171, filed on Jun. 18, 2007.

(51) Int. Cl. G06Q 40/00

(52) U.S. Cl. 705/36 R; 705/37

(57) ABSTRACT

A method for reorganizing the stock of a publicly traded corporation. The method includes issuing a mandatory fractional dividend of free trading stock for each outstanding share of free trading stock. The method also includes exchanging all prior outstanding free trading shares for non-trading securities that can be converted back into free trading shares, thereby yielding positive impacts on stock price, market cap, investor psychology, trading characteristics and institutional marketability.

### FIELD OF THE INVENTION

The present invention generally pertains to methods for reorganizing the stock structure of a publicly traded corporation, and more particularly, it pertains to methods for reducing the number of publicly traded shares, i.e., the “public float,” without reducing the number of shares held by each existing shareholder, thereby minimizing negative price impacts of the reorganization and providing favorable conditions for price appreciation and market capitalization increases.

### BACKGROUND OF THE INVENTION

Small publicly traded corporations often suffer from problems relating to low numbers of shareholders, lack of market activity, few or no market makers, lack of liquidity, a high degree of price volatility (both upwards and downwards), vulnerability to short selling (including “naked shorting”), and the like.

The stocks of highly speculative development stage public corporations with shares priced below Five US dollars (US $5.00), also known as “penny stocks,” suffer from these characteristics to an even greater degree. The penny stock market has unique trading characteristics including capital raising and float management activities that might not be feasible with more highly valued or heavily watched and analyzed stocks.

Managers and promoters will sometimes cause to be issued large numbers (millions or billions) of shares at extremely low prices (such as US $0.00001 or less), which can be attractive to investors seeking speculative returns, since it costs little to acquire a large number of shares, and if the price or such a stock should rise above 1 cent or 10 cents, the return on investment can be 1000% or better, thus possibly making up for the fact that most such stocks will not perform this well.

A convertible debenture is a debt instrument that can be converted into stock at the option of the holder or the issuer. Instead of receiving payment, the buyer of the debenture can chose to take stock in the company. With convertible debentures, the cost of borrowing is lower for the seller since the buyer has the option of converting it into stock. Debentures are tools used by companies to raise capital for their projects and operations. This is known as a debt offering since the company literally goes into debt to the investors until the price of the debenture is paid back, plus interest, or until it is converted into stock. The company must record this debt in their balance sheet. If bankruptcy occurs, the debenture holders are considered creditors and must be paid back by the companies remaining assets. Debentures are a way for companies to raise capital without having to use their assets or give up ownership in their company. This leaves their assets free to do other things to generate capital for the business.

On occasion, promoters may cause a company to affect forward or reverse stock splits of 100-for-1 or 1000-for-1 in an attempt to raise market capitalization, and the paper wealth of their shareholders, since a stock's trading price will generally not fall by the entire increment of the split. However, such actions are not always successful, and if the company's underlying business does not achieve the hoped-for next milestones, news announcements, or revenue targets, its stock price and market capitalization may sink even lower.

In some cases the issuing corporation may find it desirable to reduce its publicly traded float, to raise its stock price, for example to maintain its qualification for listing in a given trading venue, or to issue a private placement to investors who demand that the total float be reduced so that stock can be sold to them at a higher price. Some interested investors may be barred from investing in companies whose stocks are below a given price level. Other reasons for float reduction may include making the stock more attractive as compensation for company employees and securing bank financing on favorable terms, by increasing the financial credibility of the company and its stock.

Thus, for a variety of reasons a publicly traded company may find itself with too many publicly traded shares at excessively depressed prices, and may need or desire to reduce its public float and increase its share price.

One common method to reduce the size of the public float is to authorize a reverse stock split, perhaps on the order of 1-for-100, in which each shareholder will receive one share for each 100 shares he or she presently holds. This decreases the float and increases the price, but often the share price will not precisely track the reverse split, i.e., it will not rise by 100×. This cuts the corporation's market capitalization and results in shareholder discontentment, since the value of their share position is reduced, generating an unrealized loss. Depending on the stock's prior trading history, the new price may fall below the stop-loss threshold of some investors, triggering a wave of selling into a market with extremely thin liquidity, further depressing the stock's price and possibly negating the hoped-for benefits of the reorganization.

### REFERENCES CITED

U.S. Pat. No. 7,065,495 by Lundgren, Jun. 20, 2006, Method and apparatus for preventing oligopoly collusion;
U.S. Pat. No. 6,629,082 by Hambrecht, et al., Sep. 30, 2003, Auction system and method for pricing and allocation during capital formation;
U.S. Pat. No. 5,193,056 by Boes Mar. 9, 1993, Data processing system for hub and spoke financial services configuration;
U.S. Pat. No. 4,346,442 by Musmanno, Aug. 24, 1982, Securities brokerage-cash management system; and

### US-PTO Board of Patent Appeals and Interferences, Ex Parte Lundgren, Appeal No. 2003-2088, Apr. 20, 2004.

Thus, it would be highly desirable to provide a method to reorganize the stock of a thinly or actively traded public corporation that can dramatically reduce its public float without adversely affecting stock price, investor psychology or trading characteristics. It would also be advantageous to make the shares more appealing to institutional investors who can buy and hold large share positions, thus achieving a more loyal shareholder base, which a speculative corporation generally desires during its development stage, with the time needed to generate positive results in regard to its products, revenues and publicity.

### SUMMARY OF THE INVENTION

Accordingly, it is a principal object of the present invention to enable reorganization of the stock of a thinly or actively traded public corporation that can dramatically reduce its public float without adversely affecting the stock price, investor psychology or trading characteristics.

It is another principal object of the present invention to make the shares of a corporation more appealing to institutional investors who can buy and hold large share positions, thus achieving a more loyal shareholder base, which a speculative corporation generally desires during its development stage.

It is one other principal object of the present invention to provide the corporation with the time needed to generate positive results in regard to its products, revenues and publicity.

A method is disclosed for reorganizing the stock of a publicly traded corporation. The method includes issuing a mandatory fractional dividend of free trading stock for each outstanding share of free trading stock. The method also includes exchanging all prior outstanding free trading shares for non-trading securities that can be converted back into free trading shares, thereby yielding positive impacts on stock price, market cap, investor psychology, trading characteristics and institutional marketability.

Methods are disclosed for reorganizing the equity securities of a publicly traded corporation. Such methods include a mandatory exchange to replace a substantial fraction of the publicly traded shares with a form of restricted or convertible non-trading securities. Thus, the number of tradable shares is temporarily reduced, preferably without reducing the total number of shares. This approach preferably has a positive impact on stock price, market cap, investor psychology, trading characteristics and institutional marketability, while affording the corporation more time to achieve its business objectives. Such objectives typically include investing in new products or processes to boost future earnings, while minimizing interim stock price fluctuations.

### DEFINITIONS AND ABBREVIATIONS

As used in the present invention the following terms and acronyms have the meanings commonly ascribed to them in the securities trading and processing industries.

| | |
|---|---|
| Articles of Incorporation | Ask (price) |
| Authorized Shares | Bank |
| Bid (price) | Board Resolution |
| Broker Bylaws | Cede & Co. |
| Clearing Houses | Common Stock |
| Company | Conversion Price |
| Convertible Debenture | Corporation |
| CUSIP Number | CUSIP Service Bureau Debenture |
| Debenture | Depository Trust Company (DTC) |
| Dilution | Dividend |
| Earnings Per Share (EPS) Exchange | Exchange |
| Ex-dividend Date | Float |
| Fractional Shares | Free-Trading Float |
| Free-Trading Stock | Institution |
| Institutional Investor | Interest |
| Investor | Investor Psychology |
| Issued Shares | Issuer |
| Liquidity | Mandatory Exchange |
| Market Capitalization | Market Maker |
| Market Participant | Naked Shorting |
| NASD | NASDAQ |
| NOBO List | Non-Objecting Beneficial Owner |
| | (NOBO) |
| NYSE | Objecting Beneficial Owner (OBO) |
| Paid-In Capital | Par Value |
| Penny Stock | Preferred Stock |
| Price Per Share (PPS) | Private Placement Public Float |
| Public Investor | Publicly Traded |
| Record Date | Registered Agent |
| Reorganization | Reporting Company |
| Restricted Stock | Reverse Stock Split |
| Rule 144 | Securities & Exchange |
| | Commission (SEC) |
| Security | Share |
| Shareholder | Shareholder List |
| Shareholder Resolution | Shareholder Vote |
| Short Selling | Speculative |
| State of Incorporation | Stated Capital |
| Stock | Stock Certificate |
| Stock Dividend | Stock Market |
| Stock Split | Stop-Loss Threshold |
| Street Name | Tax-Free Exchange |
| Thinly Traded | Total Float |
| Trading History | Trading Venue |
| Transfer Agent | Uncertificated Securities |
| Unit | Volatility |
| Volume | |

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic flow diagram of the planning process for a hypothetical corporate investment program, constructed in accordance with an embodiment of the present invention;

FIG. 2 shows a simplified example of the anticipated results of a stock reorganization with phased lapse dates hypothetical corporate investment program, as described according to FIG. 1, constructed in accordance with an embodiment of the present invention;

FIG. 3 is a schematic flow diagram of a first exemplary method, constructed in accordance with an embodiment of the present invention; and

FIG. 4 is a schematic flow diagram of a second exemplary method, constructed in accordance with an embodiment of the present invention.

### DETAILED DESCRIPTION OF A PREFERRED EMBODIMENT

The principles and operation of a method and an apparatus according to the present invention may be better understood with reference to the drawings and the accompanying description, it being understood that these drawings are given for illustrative purposes only and are not meant to be limiting.

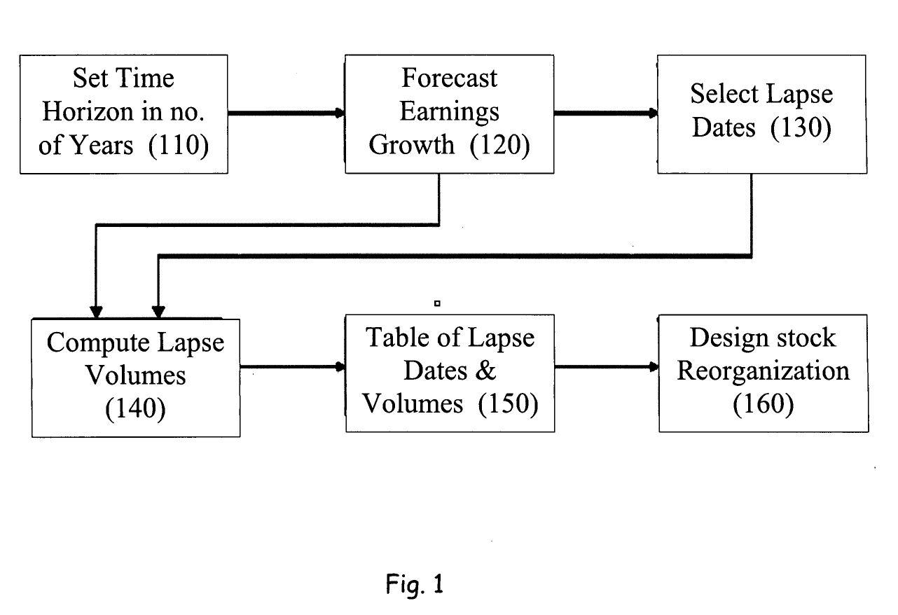

FIG. 1 is a schematic flow diagram of the planning process for a hypothetical corporate investment program, constructed in accordance with an embodiment of the present invention. A time horizon is established, for example 5 years, for the investments to take place and bear fruit 110. Then an earnings growth forecast is prepared 120. Then a schedule of lapse dates is established 130, such as quarterly, upon which the restrictions on the restricted securities will lapse, shifting them back into the free-trading float. In the next step a set of lapse volumes in the form of a table is computed that optimally correlates the timing and amount of lapses with the earnings growth forecast, so as to minimize the price impact of the lapses. The resulting table of lapse dates and volumes is produced 150, which in turn drives the overall design of the stock reorganization process 160.

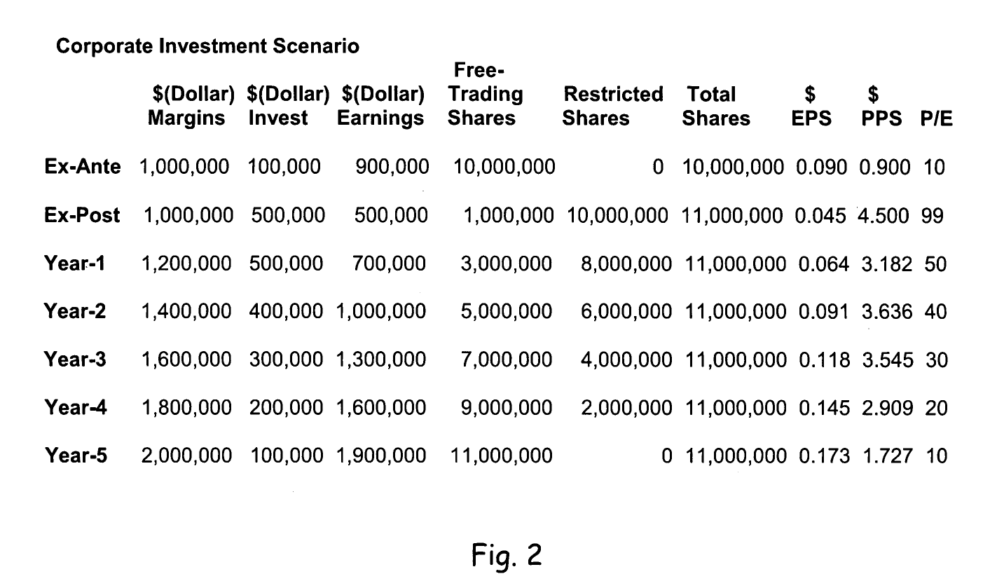

FIG. 2 shows a simplified example of the anticipated results of a stock reorganization with phased lapse dates, as described above according to FIG. 1, constructed in accordance with an embodiment of the present invention. The corporation has earnings of US $1 million per year 210 and invests $100,000 per year 220 to maintain competitiveness. With 10 million shares outstanding 230 it earns US$0.09 per share 240, for a market price of US$0.90 per share based on a price-earnings multiple of ten (10) 250.

The corporation wishes to substantially increase investments, for example to transition to a new technology without a dramatic and prolonged stock price decline. One such transition occurs in switching from film cameras to digital cameras. It thus reorganizes its equity float structure by issuing 1 million new free trading shares and exchanging the 10 million prior shares for restricted shares with lapse dates phased over a 5-year period. During the 5-year period 260 it doubles its income to US$2 million 270 and scales back investment to previous levels. Although the lapsing share restrictions are increasing its outstanding shares it is counteracting the effects of such dilution with regular earnings increases, leading to an ending condition in which its target stock price has almost doubled to US $1.73 per share 280, while the total number of shares has increased only modestly, due to the initial share dividend. The forecast stock prices and P/E rations are hypothetical, and may not remain above normal for such long periods, unless management undertakes a coordinated ongoing media and investor relations campaign to build awareness of its investment plans and expected results.

The method and system of the present invention can accomplish these and other concrete, useful, and tangible results by effecting a mandatory exchange of the prior common stock for a package or unit that includes a smaller number of freely trading shares combined with a complementary number of non-trading (restricted or convertible) securities such that the total number of shares held, or potentially held, by the shareholder is not reduced.

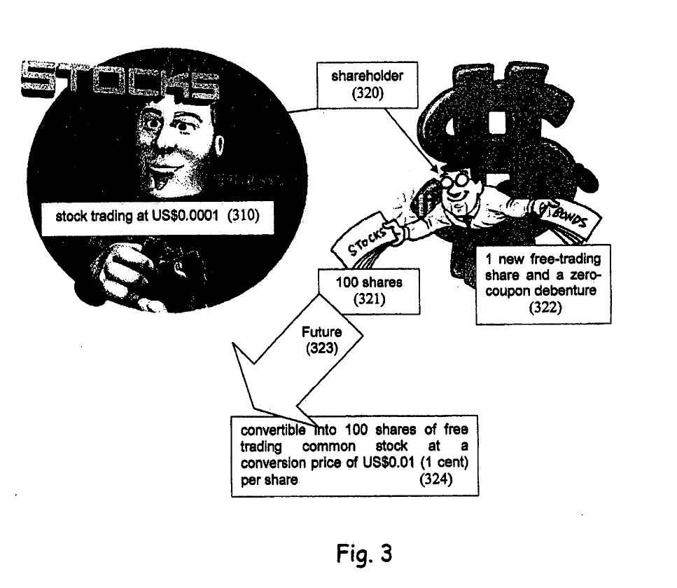

FIG. 3 is a schematic flow diagram of a first exemplary method, constructed in accordance with an embodiment of the present invention.

Method 1: Convertible Debentures: In one embodiment a mandatory exchange is effected.
For example, for every one hundred (100) free trading common shares held by a shareholder he or she will receive one (1) free trading share and a convertible debenture that is a debt obligation of the corporation convertible into one hundred (100) common shares at some time in the future.

### Example

Consider a stock trading at US$0.0001 310. For each 100 shares 321 held, the shareholder 320 receives 1 new free-trading share and a zero-coupon debenture obligating the company to pay 100×US$0.0001=US$0.01 (1 cent) 322 in the future 323, convertible into 100 shares of free trading common stock at a conversion price of US$0.01 (1 cent) per share 324. If there is a concern that the debenture holders might force the company into bankruptcy if it were unable to pay the debt obligation at maturity, the debentures can optionally be issued by a subsidiary, including a foreign subsidiary.

One problem with the convertible debentures method is that it reduces the number of shares held by the shareholder, creating negative investor psychology.

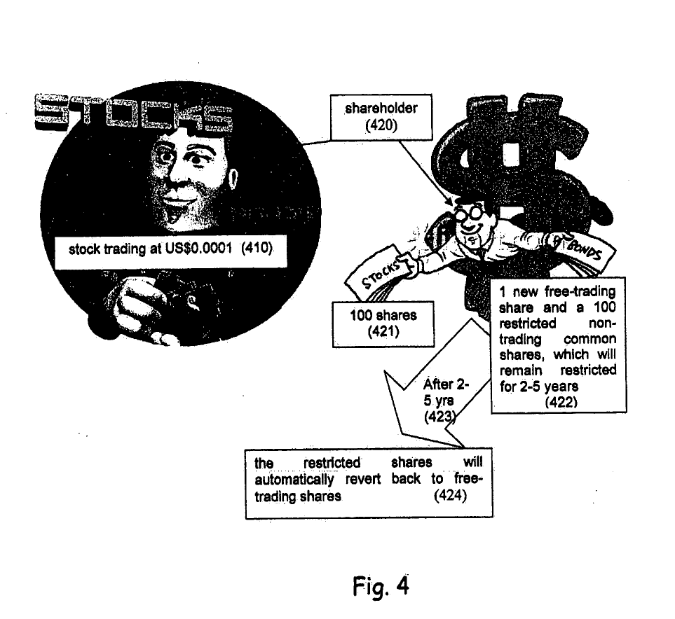

FIG. 4 is a schematic flow diagram of a second exemplary method, constructed in accordance with an embodiment of the present invention.

Method 2: Restricted Shares. In a preferred embodiment another mandatory exchange is described by way of example. Again, a stock is trading at US$0.0001 410. For every one hundred (100) free trading common share 421 held by a shareholder 420 he or she will receive one (1) free trading share and 100 restricted non-trading common shares, which will remain restricted for 2-5 years 422, whereupon the restricted shares will automatically revert back to free-trading shares 424 after the 2-5 years 423.

(Note: This can be regarded as two separate steps, i.e., a dividend of one-hundredth ( 1/100) of a new free-trading share per existing share followed by the exchange of one (1) existing share for one (1) restricted share. However, to minimize administrative burden on market participants it will be preferable to combine them into a single corporate action.)

This restricted shares method has a less negative effect on investor psychology, since the number of share they hold has not decreased, and in fact has slightly increased.

The same legal authority is available for effecting this reorganization as for effecting a stock dividend, reverse split, or forward split.

The procedure for this corporate action starts with a Board Resolution authorizing this action followed by notification of this action to the NASDAQ ten (10) calendar days prior to the record date set by the corporate resolution. NASDAQ should then notify the markets, including the Depository Trust Company (DTC) of the corporate action resulting in a record date (or ex-dividend date) that will give a line of demarcation. Buyers and sellers of shares will thereby know whether they are buying or selling shares before or after the float reduction. Because this is a mandatory corporate action, DTC will surrender to the transfer agent all of the shares they hold in the issue and request in exchange thereof the same number of shares in restricted form and a certificate for the 1% dividend, according to the method 2 described in FIG. 4 example above.

The benefits and consequences of such an exchange include the following—
1. The action may or may not require shareholder approval under state law of the corporation's articles of incorporation or bylaws since no class of shareholders is discriminated against or loses rights relative to another.
2. The action has no immediate federal or state tax consequences.
3. The size of the free-trading float is greatly reduced, for example by a factor of 100 to 1, making the stock more attractive to investors including institutional investors, although the total float remains roughly the same.
4. The total number of shares held by a given shareholder does not change significantly, although they will be required to wait several years before selling them, thus reducing the negative impact on investor psychology. Note that investors with large numbers of shares had already experienced substantial illiquidity. Thus in many cases exchanging a portion of their free-trading shares for non-trading shares may not significantly reduce their liquidity.
5. Reducing the free-trading float will generally have a strongly positive impact on share price, since investors, especially future investors, tend to focus their investment decisions on a stock's free-trading float, not exclusively its total issued and outstanding. Since the price per share of stock in the market is mostly the result of supply and demand, with a greatly reduced float, the share price will increase if the demand for the company's shares remains the same.
6. Some disgruntled investors may decide to sell their shares, not necessarily realizing that they now have far fewer shares to sell, because they were not properly notified by their brokerage firms, or clearing houses, possibly generating short sales, wherein they will be forced to buy at increasing prices in order to cover their short positions, possibly rewarding more loyal investors with price appreciation and liquidity.
7. As the trading price rises, due to the foregoing factors, loyal investors will see the value of their shares, both trading and non-trading, rise dramatically, creating an abundance of paper wealth and corresponding positive investor psychology.
8. Due to the unique trading characteristics resulting from the exchange of the present invention, a significant and prolonged share price appreciation is virtually guaranteed, possibly on the order of 100-to-1 (that is 10,000%). However, a modest 10% increase would be enough to justify this type of corporate action. For example, a stock that was trading at US$0.15 could as a result of this action of re-restriction appreciate to a price of US$1.00 or more.
9. In anticipation of this type of corporate action, or immediately after the stock price begins to rise after the reorganization is complete, the company can issue additional restricted stock at a 50% discount from market (or at market from a Regulation A or other exempt offering) to qualified investors seeking to improve their investment performance. Such placements of restricted stock can raise much-needed capital to fund the subject company's speculative development plans. This can be attractive to the investors. This is because, while their purchase price per share remains relatively low, at or below the pre-exchange level, the restricted stock is virtually assured to experience dramatic and potentially sustained price appreciation. This is owing to the float reduction and price appreciation of the corresponding publicly traded shares.
   If the issuing company fails to achieve its development and growth objectives before the restrictions expire, the share price may collapse due to a sudden rise in the free-trading float. However, sophisticated investors routinely hedge against such risks by maintaining a well-diversified portfolio. They also hedge by limiting their total exposure to speculative thinly traded stocks, so that they are positioned to manage and mitigate the risk.
10. There is no obvious negative moral consequence from the expiration of the restrictions, since the resulting increase in public float will be almost exactly the same as had existed prior to the reorganization.
11. Under the scenarios outlined above, in which free trading shares are exchanged for restricted non-trading securities, major depository institutions, such as the DTC, will likely be unwilling to retain custody of the resulting non-trading (“non-eligible”) securities, and will convey them back to their member banks, brokers, and clearing houses (collectively, “institutions”) that hold the underlying customer accounts. This may generate up to 100 transfers of the non-trading securities from the DTC to its 100 or so institutional members, at a cost of around US $2,500 borne by the institutions. If some institutions then decide to transfer the restricted shares to their clients in certificate form this could generate, for example, an additional 2,000 physical certificate requests at an additional cost of US $50,000. The corporation's board of directors should take note that these external costs could generate negative goodwill with institutions holding the corporation's stock or managing customer accounts, which may be undesirable since most companies seek to promote goodwill among entities processing its stock.
12. The date(s) on which the restrictions will lapse are publicly known in advance, facilitating short selling, including naked shorting, of the stock in anticipation of these lapse dates. This potential downside also has the positive effect of requiring company management to exercise discipline and restraint when using these methods of equity float reorganization. Thus, when the restrictions lapse, thereby increasing the public float, if successful, the company's earnings and growth prospects will be positive enough that the stock can withstand any potential short selling that may occur.

### More Advanced Strategies

1. Applicability to Larger Companies

The foregoing discussion has focused primarily on small companies with thinly traded stock where the benefits of such reorganizations would be obvious and immediate. However, the present invention can be applied equally to large public companies.

For example, a large public company may experience undesirable dilution of its shares after a major acquisition that fails to pan out when the acquired company loses much of its value. In such a case it has many of the same problems as a small overly-diluted company: its stock's market priced has declined making it less valuable as compensation to its employees, the decline of value of employee stock plans greatly reduces workforce morale, the price decline may cause it to fall out of favor with institutional investors, the value of the stock as collateral for bank loans or as an indicator of corporate health is impaired, it is less attractive to corporate joint venture partners, its stock becomes useless as a currency to acquire other companies, since far too much of it is required to make a purchase, and so on.

Thus even though the company's fundamentals are as strong as ever, it may suffer many negative consequences from an inordinately low share price, making it a candidate for the methods of stock reorganization of the present invention. The benefits of these methods are not limited to small or thinly capitalized companies.

2. Phased Lapsing of Restrictions

As a further variation, in a preferred embodiment, a corporation can effect a stock reorganization using phased lapse dates. For example, management may desire to invest in developing new products or markets to insure the company's long-term growth and viability, but be deterred because such investments will decrease reported earnings, disappoint analysts' expectations, trigger a stock price decline, and punish the company and its employees and investors. Such fears have been blamed for fostering a sort-term mentality as many corporations seek to generate smoothly increasing quarterly profits, while ignoring needed repairs and investments, eventually leading to severe stock price declines when such costs can no longer be deferred.

To address this problem, corporate management can for example (a) outline the investments it plans to make and the time horizons at which they will pay off (by yielding substantial earnings increases say 2-5 years in the future), (b) carry out the actions described above to decrease their free-trading float (for example) by a factor of ten by issuing one-tenth of a free-trading share for each existing share and then converting each pre-existing share into a restricted share.

However, in this case the share restrictions are not all the same. Instead, the restrictions may lapse in phases, such as one-fifth (⅕) becoming unrestricted every year for five years, or one-tenth ( 1/10) every year for ten years. This phased lapsing of the restrictions can be timed to coincide with expected earnings gains from the investment program, such that earnings per share (EPS) will not be diluted by the lapsing of the restrictions and the resulting increases in the free trading float, but rather the correlated rise of EPS and share float will result in favorable trading conditions and stable or rising stock price during the investment program.

3. Further Variations

Many further variations may be employed to address various circumstances and/or tune the procedures to a given company's situation. These may include, without limitation—
1. Initially reducing the free-trading float by a lesser proportion, such as 20-50% rather than 99% as shown in the examples.
2. Varying the type and/or terms of the non-trading replacement security.
3. Breaking the corporate action into several separate actions (increasing processing costs for market participants, and potential negative goodwill).
4. Scheduling the restricted share lapse dates more frequently (such as monthly or even weekly), to minimize the impact of dilution and corresponding short selling opportunities.
5. Fine-tuning the numbers of shares lapsing during a given period to more accurately track the anticipated earnings improvements, including non-straight line lapse programs.
6. Issuing to each shareholder a single restricted share certificate that reflects a range of lapse dates (thereby reducing processing costs for market participants, with potential positive goodwill).
7. g. Applying the method simultaneously to multiple classes of listed (or unlisted) stock, including both common and preferred shares.

4. Factors Affecting Share Price

As shown in the hypothetical example of FIG. 2 described above, one effect of the present invention is to trigger a substantial increase in the market price of the corporation's free-trading shares, leading to a large increase in its market capitalization based on total shares outstanding. This effect may occur in spite of a reduction of earnings per share (EPS) (such as due to embarking on an investment program) or possibly no change in EPS. Therefore the price change is not based on fundamentals, such as earnings or growth rates, but rather is due mainly to technical factors, which may include:

Reduction of supply relative to extant level of demand

Increased investor awareness

Upward price movement attracts momentum-seeking investors

Activity, a higher percentage of the total float turns over each day

Rising stock price
Increases price-earnings (P/E) ratio
Daily value turnover is higher
Company appears more important and valuable

Misguided short selling
Investors could (wrongly) foresee a falling stock price
Investors might sell more shares than they have (after the reduction) if brokerage firms do not give proper notice to their clients.
Must buy shares to cover short position in face of rising prices

These technical factors can be leveraged to bolster the stock's price, and give the company more credibility with its employees, customers, and business partners, but management must deliver hoped-for earnings increases in a timely manner or face the possibility that the price and market capitalization gains will dissipate, especially as the restrictions lapse bringing more shares back into the free-trading float. Thus the invention can serve as a tool to aid management in building the company, by keeping stakeholders interested in its success, but is not a substitute for a well considered and executed business plan that delivers solid long-term earnings growth.

Although the invention has been described with a certain degree of particularity, it should be understood that various changes can be made to it by those skilled in the art without departing from the spirit or scope of the invention as hereinafter claimed.

We claim:

1. A method for reorganizing the stock of a publicly traded corporation, said method comprising:
issuing a mandatory fractional dividend of free trading stock for each outstanding share of free trading stock; and
exchanging all prior outstanding free trading shares for non-trading securities that can be converted back into free trading shares,
thereby yielding positive impacts on stock price, market cap, investor psychology, trading characteristics and institutional marketability.

2. The method of claim 1 wherein the non-trading security is a convertible debenture.

3. The method of claim 1, wherein the corporation is afforded more time to achieve its business objectives.

4. The method of claim 1, wherein the corporation acts as its own transfer agent.

5. The method of claim 1 wherein said business objectives comprise at least investing in one of new products and processes to boost future earnings, while minimizing interim stock price impacts.

6. The method of claim 1, wherein the non-trading security is restricted stock.

7. The method of claim 1, wherein the fractional dividend is one-half of a share or less.

8. The method of claim 1, wherein the fractional dividend is one-fifth of a share or less.

9. The method of claim 1, wherein the fractional dividend is one-tenth of a share or less.

10. The method of claim 1, wherein the fractional dividend is one-hundredth of a share or less.

11. The method of claim 6 wherein the restricted stock is divided into multiple series having phased lapse dates.

12. A method for reorganizing the stock of a publicly traded corporation, said method comprising:
issuing, for each outstanding share of free trading stock, a fractional dividend of one-fifth of a share or less of free trading stock; and
exchanging all prior outstanding free trading shares for restricted shares,
thereby yielding positive impacts on at least one of stock price, market cap, investor psychology, trading characteristics and institutional marketability.

13. The method of claim 12 wherein the corporation is afforded more time to achieve its business objectives.

14. The method of claim 12 wherein the restricted shares are divided into multiple series having phased lapse dates.

15. The method of claim 12, wherein the corporation acts as its own transfer agent.
